(19) United States
(12) Patent Application Publication
(10) Pub. No.: US 2026/0103991 A1
(43) Pub. Date: Apr. 16, 2026

(54) INTERMEDIATE SHAFT COVER, AND GAS TURBINE PROVIDED WITH SAME

(71) Applicant: MITSUBISHI HEAVY INDUSTRIES, LTD., Tokyo (JP)

(72) Inventors: Yusuke AKADA, Tokyo (JP); Elichi TSUTSUMI, Tokyo (JP); Ikko TSUBOKURA, Tokyo (JP)

(21) Appl. No.: 19/113,250

(22) PCT Filed: Sep. 25, 2023
(86) PCT No.: PCT/JP2023/034716

§ 371 Date: Mar. 19, 2025

(30) Foreign Application Priority Data
Oct. 4, 2022 (JP) 2022-160173

(51) Int. Cl. F01D 9/06; F01D 5/08

(52) U.S. Cl. CPC F01D 9/065; F01D 5/087; F05D 2240/35; F05D 2260/232

(57) ABSTRACT

This intermediate shaft cover comprises: a cylindrical inner cover covering an intermediate rotor shaft; an annular outer cover which covers an outer peripheral side of a diffuser space and which is connected to a gas turbine casing; and a strut which extends radially outward from an outer periphery of the inner cover, and which is connected directly or indirectly to the outer cover. The strut has a thick-walled portion and a thin-walled portion having a circumferential-direction thickness that is less than that of the thick-walled portion. The thick-walled portion is formed in a region of the strut including an outer connecting portion connected directly or indirectly to the outer cover. The thin-walled portion is formed in a region of the strut including an inner connecting portion connected to the inner cover.

### TECHNICAL FIELD

The present disclosure relates to an intermediate shaft cover and a gas turbine provided with the same.

Priority is claimed on Japanese Patent Application No. 2022-160173, filed Oct. 4, 2022, the content of which is incorporated herein by reference.

### BACKGROUND ART

A gas turbine includes a compressor that compresses air, a combustor that combusts fuel in the air compressed by the compressor to generate a combustion gas, a turbine that is driven by the combustion gas, and an intermediate casing.

The compressor includes a compressor rotor rotatable about an axis, a compressor casing that covers the compressor rotor, and a diffuser. The compressor rotor has a compressor rotor shaft that extends in an axial direction centered on the axis, and a plurality of compressor rotor blade rows that are provided on the compressor rotor shaft. The diffuser forms an annular diffuser space through which air that has passed through the plurality of compressor rotor blade rows passes. The diffuser has an outer diffuser that defines an outer peripheral edge of the diffuser space and an inner diffuser that defines an inner peripheral edge of the diffuser space. The turbine includes a turbine rotor that is rotatable about the axis, and a turbine casing that covers the turbine rotor. The turbine rotor has a turbine rotor shaft that extends in an axial direction centered on the axis, and a plurality of turbine rotor blade rows provided on the turbine rotor shaft.

The compressor rotor and the turbine rotor are connected to each other to form a gas turbine rotor. In the gas turbine rotor, an intermediate rotor shaft, in which rotor blade rows are not provided, is formed between the plurality of compressor rotor blade rows and the plurality of turbine rotor blade rows in the axial direction. An intermediate casing that covers the intermediate rotor shaft is disposed between the compressor casing and the turbine casing. The compressor casing, the intermediate casing, and the turbine casing are connected to each other to form a gas turbine rotor. The combustor is attached to the intermediate casing.

The gas turbine described in the following PTL 1 further includes an intermediate shaft cover. The intermediate shaft cover includes a tubular inner cover that covers an outer periphery of the intermediate rotor shaft, and a plurality of struts that extend from an outer periphery of the inner cover in a radial direction with respect to the axis. The plurality of struts are arranged in a circumferential direction with respect to the axis. An end of the strut on a radial outer side is connected to an end of the outer diffuser on an axial downstream side.

The air jetted from the diffuser of the compressor passes through spaces between the plurality of struts and flows into the combustor.

### CITATION LIST

### Patent Literature

[PTL 1] International Publication No. WO2018/181902

### SUMMARY OF INVENTION

### Technical Problem

In the field of gas turbines including an intermediate shaft cover, there is a demand for increasing strength of a connecting portion between a plurality of struts and an outer diffuser. Meanwhile, in this field, there is also a demand for suppressing resistance in a process in which air passes through spaces between a plurality of struts after being jetted from a diffuser of a compressor.

Therefore, an object of the present disclosure is to provide an intermediate shaft cover capable of suppressing resistance of a flow of air from the compressor while increasing strength of a strut, and a gas turbine provided with the same.

### Solution to Problem

The intermediate shaft cover as one aspect for achieving the object is applied to the following gas turbine.

The gas turbine includes a gas turbine rotor that is rotatable about an axis, and a gas turbine casing that covers an outer periphery of the gas turbine rotor. The gas turbine rotor includes a gas turbine rotor shaft that extends in an axial direction, a plurality of compressor rotor blade rows that are provided in a portion of the gas turbine rotor shaft on an axial upstream side among the axial upstream side and an axial downstream side in the axial direction, and a plurality of turbine rotor blade rows that are provided in a portion of the gas turbine rotor shaft on the axial downstream side with an interval from the plurality of compressor rotor blade rows to the axial downstream side.

The intermediate shaft cover includes a diffuser through which compressed air that has passed through the plurality of compressor rotor blade rows can flow and which forms an annular diffuser space centered on the axis, a tubular inner cover that covers an intermediate rotor shaft between the plurality of compressor rotor blade rows and the plurality of turbine rotor blade rows in the gas turbine rotor shaft, on the axial downstream side with respect to the diffuser, an annular outer cover that covers an outer peripheral side of the diffuser space and that is connected to the gas turbine casing, and a strut that extends from an outer periphery of the inner cover to a radial outer side with respect to the axis and that is directly or indirectly connected to the outer cover. The strut includes a thick wall portion having a large thickness in a circumferential direction with respect to the axis and a thin wall portion having a smaller thickness in the circumferential direction than the thickness of the thick wall portion. The thick wall portion is formed in a region including an outer connecting portion that includes an end on the radial outer side and that is directly or indirectly connected to the outer cover, in the strut. The thin wall portion is formed in a region including an inner connecting portion that includes an end on a radial inner side with respect to the axis and that is connected to the inner cover, in the strut.

In the present aspect, in the strut, a thick wall portion having a larger thickness in the circumferential direction than the thickness of the thin wall portion is formed in a region including an outer connecting portion that is directly or indirectly connected to the outer cover. Therefore, strength of the outer connecting portion in the strut can be increased. Moreover, in the present aspect, in the strut, a thin wall portion having a smaller thickness in the circumferential direction than the thickness of the thick wall portion is formed in the region including the inner connecting portion connected to the inner cover. Therefore, it is possible to suppress narrowing of a width of a flow path of the compressed air that is jetted from the diffuser to pass through a side of the strut. Therefore, in the present aspect, it is possible to suppress resistance in a process in which the compressed air passes through the side of the strut.

The gas turbine as one aspect for achieving the object includes an intermediate shaft cover as the one aspect, the gas turbine rotor, the gas turbine casing, and a combustor that is attached to the gas turbine casing and that generates combustion gas by combusting fuel in compressed air that has passed into the diffuser space.

The combustor is formed such that the combustion gas is guided to the plurality of turbine rotor blade rows.

### Advantageous Effects of Invention

In one aspect of the present disclosure, it is possible to suppress the resistance of the flow of air from the compressor while increasing the strength of the strut.

### BRIEF DESCRIPTION OF DRAWINGS

FIG. 1 is a schematic configuration view of gas turbine equipment in an embodiment according to the present disclosure.

FIG. 2 is a cross-sectional view of a main part of a gas turbine around an intermediate shaft cover in a first embodiment according to the present disclosure.

FIG. 3 is a cross-sectional view of a main part of the intermediate shaft cover in the first embodiment according to the present disclosure.

FIG. 4 is a developed view showing a state in which the intermediate shaft cover in the first embodiment according to the present disclosure is developed in a circumferential direction, to be viewed from a radial outer side.

FIG. 5 is a cross-sectional view taken along line V-V in FIG. 4.

FIG. 6 is a cross-sectional view of a main part of a gas turbine around an intermediate shaft cover in a second embodiment according to the present disclosure.

FIG. 7 is a cross-sectional view of a main part of a gas turbine around an intermediate shaft cover in a third embodiment according to the present disclosure.

FIG. 8 is a cross-sectional view of a main part of a gas turbine around an intermediate shaft cover in a fourth embodiment according to the present disclosure.

### DESCRIPTION OF EMBODIMENTS

Hereinafter, an embodiment of gas turbine equipment including an intermediate shaft cover according to the present invention and various embodiments of the intermediate shaft cover will be described with reference to the drawings.

### Embodiment of Gas Turbine Equipment

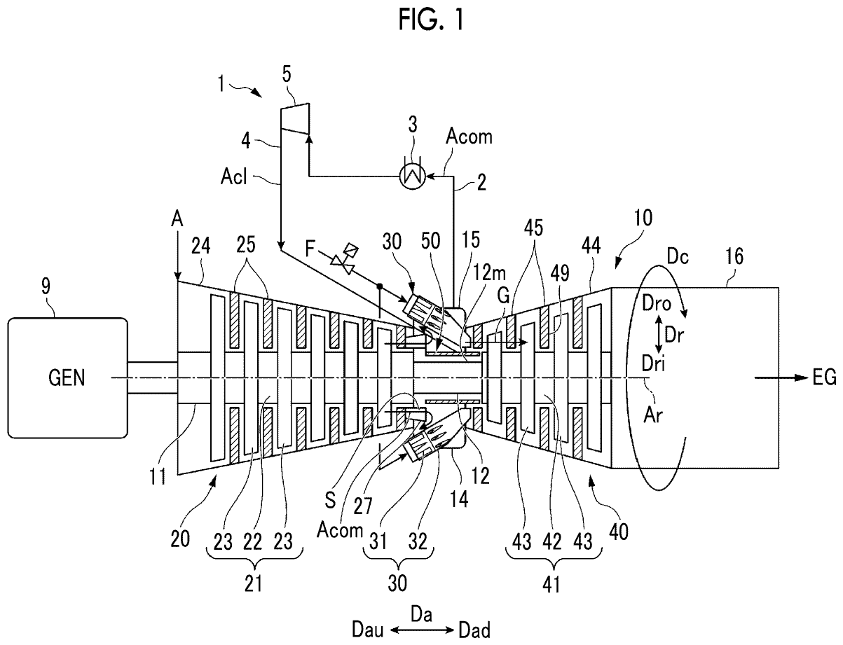

Hereinafter, an embodiment of the gas turbine equipment will be described with reference to FIG. 1.

As shown in FIG. 1, the gas turbine equipment of the present embodiment includes a gas turbine 10 and a cooling air supply device 1 that feeds cooling air Acl to some components of the gas turbine 10.

The gas turbine 10 includes a compressor 20 that compresses air A to generate compressed air Acom, a plurality of combustors 30 that combust fuel F in the compressed air Acom to generate combustion gas G, a turbine 40 driven by the combustion gas G having a high temperature and a high pressure, an exhaust casing 16 through which exhaust gas EG which is the combustion gas G exhausted from the turbine 40 flows, an intermediate casing 15, and an intermediate shaft cover 50.

The compressor 20 has a compressor rotor 21 that is rotatable about an axis Ar, a compressor casing 24 that covers the compressor rotor 21, a plurality of compressor stator vane rows 25, and a diffuser 26. The turbine 40 has a turbine rotor 41 that is rotatable about the axis Ar, a turbine casing 44 that covers the turbine rotor 41, and a plurality of turbine stator blade rows 45. Hereinafter, an extending direction of the axis Ar will be referred to as an axial direction Da, a circumferential direction centered on the axis Ar will be simply referred to as a circumferential direction De, and a direction perpendicular to the axis Ar will be referred to as a radial direction Dr. In addition, one side in the axial direction Da will be referred to as an axial upstream side Dau, and a side opposite thereto will be referred to as an axial downstream side Dad. In addition, a side closer to the axis Ar in the radial direction Dr will be referred to as a radial inner side Dri, and a side opposite thereto will be referred to as a radial outer side Dro.

The compressor 20 is disposed on the axial upstream side Dau with respect to the turbine 40. In addition, the exhaust casing 16 is disposed on the axial downstream side Dad with respect to the turbine 40.

The compressor rotor 21 has a compressor rotor shaft 22 that extends in the axial direction Da centered on the axis Ar, and a plurality of compressor rotor blade rows 23 attached to the compressor rotor shaft 22. The plurality of compressor rotor blade rows 23 are arranged in the axial direction Da. Each compressor rotor blade row 23 is configured by a plurality of rotor blades arranged in the circumferential direction Dc. Any one compressor rotor blade row 25 among the plurality of compressor stator vane rows 25 is disposed on each axial downstream side Dad of the plurality of compressor rotor blade rows 23. Each compressor stator vane row 25 is provided inside the compressor casing 24. Each compressor stator vane row 25 is composed of a plurality of stator blades arranged in the circumferential direction Dc.

The diffuser 26 forms a diffuser space S through which air that has passed through the plurality of compressor rotor blade rows 23 passes. The diffuser space S is an annular space centered on the axis Ar.

The turbine rotor 41 includes a turbine rotor shaft 42 extending in the axial direction Da centered on the axis Ar, and a plurality of turbine rotor blade rows 43 attached to the turbine rotor shaft 42. The plurality of turbine rotor blade rows 43 are arranged in the axial direction Da. Each turbine rotor blade row 43 is composed of the plurality of rotor blades arranged in the circumferential direction De. Any one turbine stator blade row 45 among the plurality of turbine stator blade rows 45 is disposed on each axial upstream side Dau of the plurality of turbine rotor blade rows 43. Each turbine stator blade row 45 is provided inside the turbine casing 44. Each turbine stator blade row 45 is composed of the plurality of stator blades arranged in the circumferential direction Dc. An annular space on an inner peripheral side of the turbine casing 44 on an outer peripheral side of the turbine rotor shaft 42 forms a combustion gas passage 49 through which the combustion gas G flows. The plurality of turbine stator blade rows 45 and the plurality of turbine rotor blade rows 43 are disposed in the combustion gas passage 49.

The compressor rotor 21 and the turbine rotor 41 are located on the same axis Ar and are connected to each other to form a gas turbine rotor 11. Therefore, the gas turbine rotor 11 has a gas turbine rotor shaft 12 extending in the axial direction Da centered on the axis Ar, and the plurality of compressor rotor blade rows 23 and the plurality of turbine rotor blade rows 43. In the gas turbine rotor shaft 12, an intermediate rotor shaft 12m is formed between the plurality of compressor rotor blade rows 23 and the plurality of turbine rotor blade rows 43. For example, a rotor of a generator 9 is connected to the gas turbine rotor 11. The intermediate casing 15 is disposed between the compressor casing 24 and the turbine casing 44 in the axial direction Da and covers the intermediate rotor shaft 12m. The compressed air Acom jetted from the diffuser 26 of the compressor 20 flows into the intermediate casing 15. The compressor casing 24, the intermediate casing 15, the turbine casing 44, and the exhaust casing 16 are connected to each other to form a gas turbine casing 14.

The intermediate shaft cover 50 is disposed in the intermediate casing 15 and covers an outer peripheral side of the intermediate rotor shaft 12m.

The plurality of combustors 30 are arranged in a circumferential direction Dc and attached to the intermediate casing 15. The combustor 30 has a combustion cylinder (or transition piece) 32 that feeds the combustion gas G having a high temperature and a high pressure to the combustion gas passage 49 of the turbine 40, and a plurality of burners 31 that inject the fuel F together with the compressed air Acom into a combustion cylinder 32. The combustion cylinder 32 is formed such that the combustion gas G can be fed into the combustion gas passage 49 of the turbine 40.

The cooling air supply device 1 includes a bleeding air line 2 for bleeding the compressed air Acom in the intermediate casing 15 from the intermediate casing 15, a cooler 3 for cooling the compressed air Acom that has flowed through the bleeding air line 2, a cooling air line 4 for guiding the cooling air Acl, which is the compressed air Acom cooled by the cooler 3, to the turbine rotor shaft 42, and a boost compressor 5 for compressing the cooling air Acl flowing through the cooling air line 4.

The compressor 20 sucks in external air A and compresses the air A to generate the compressed air Acom. The compressed air Acom is jetted from the diffuser 26 of the compressor 20 into the intermediate casing 15. The compressed air Acom in the intermediate casing 15 flows into the combustor 30. The burner 31 of the combustor 30 injects the compressed air Acom along with the fuel F that has been fed from the outside into the combustion cylinder 32. In the combustion cylinder 32, the fuel F is combusted in the compressed air Acom to be the combustion gas G. The combustion gas G is fed to the combustion gas passage 49 of the turbine 40 to rotate the turbine rotor 41.

### First Embodiment of Intermediate Shaft Cover

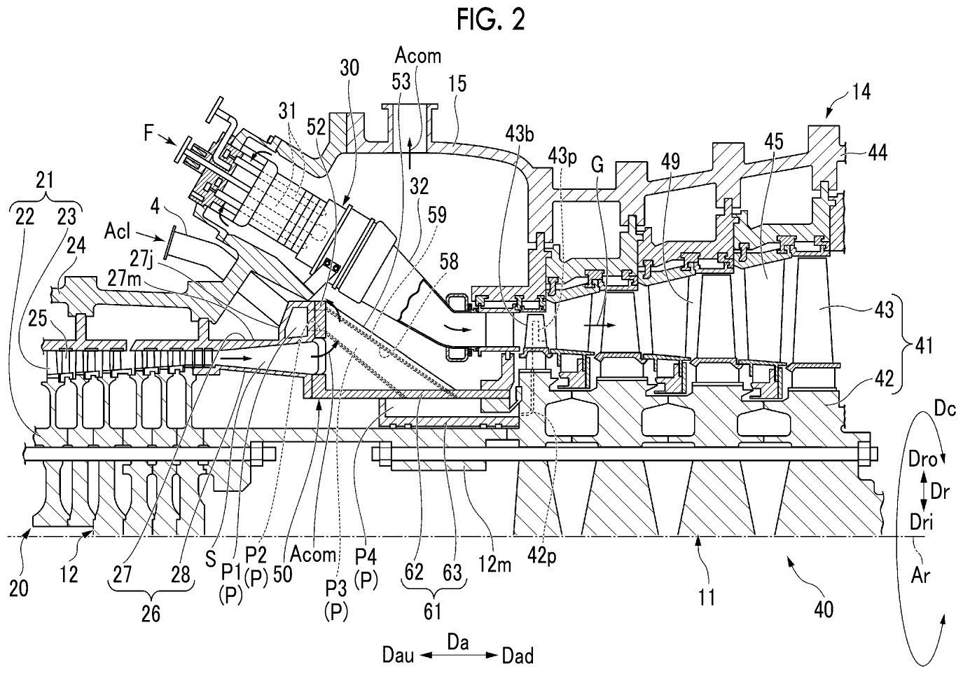

A first embodiment of the intermediate shaft cover will be described with reference to FIGS. 2 to 5.

As shown in FIG. 2, the intermediate shaft cover 50 in the present embodiment includes the diffuser 26, an inner cover 61, a flange 52, a plurality of struts 53, and a passage cover 59 provided for each of the plurality of struts 53.

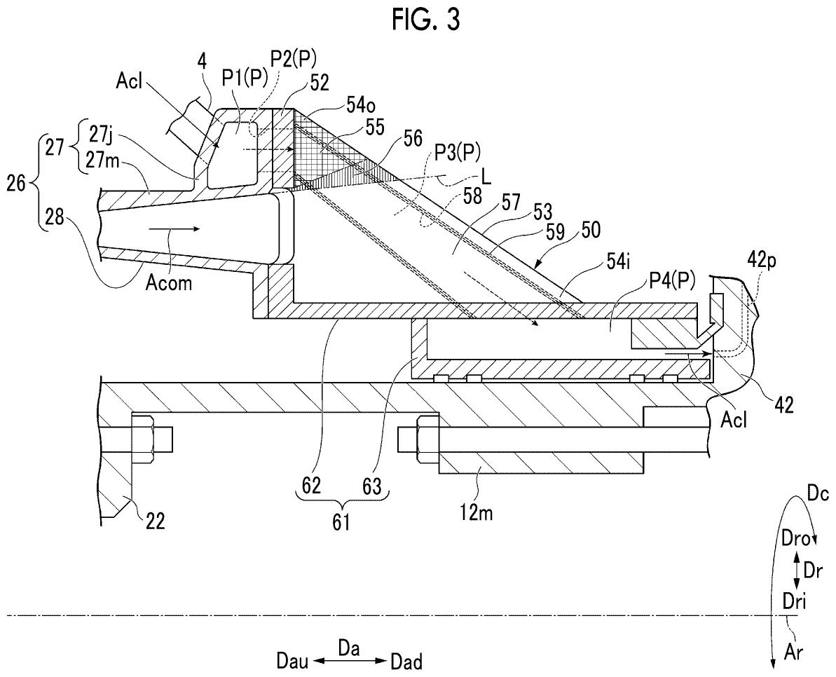

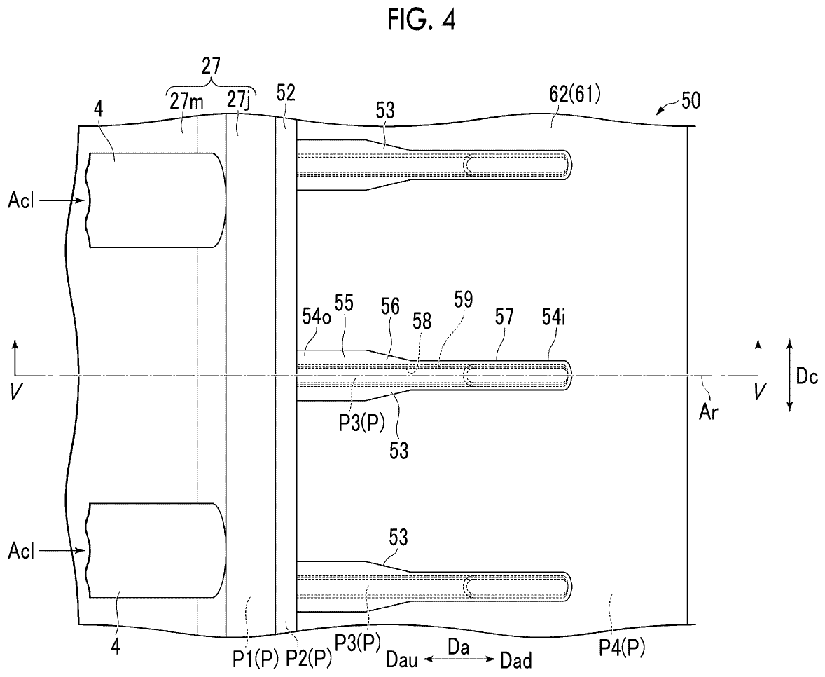

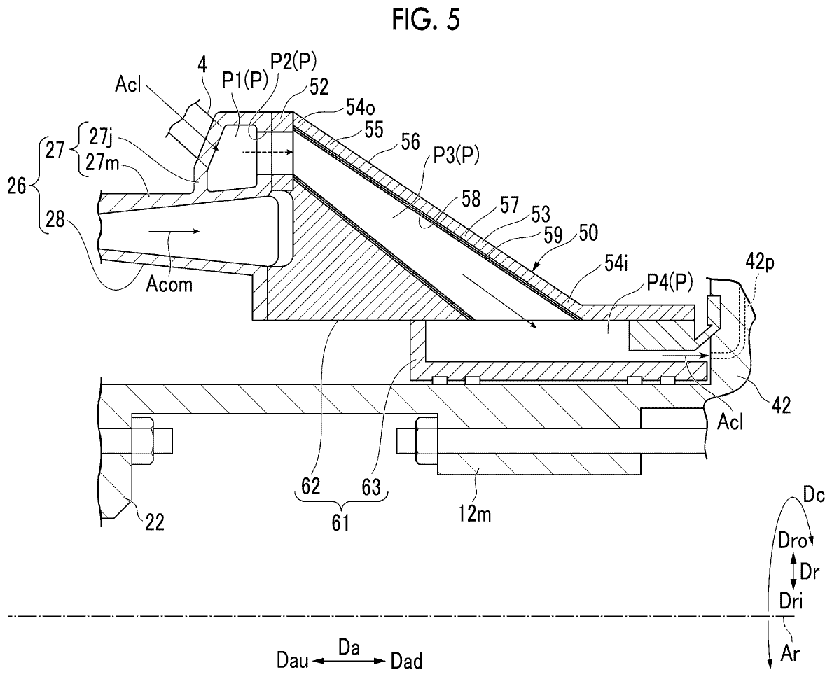

The diffuser 26 is the diffuser 26 of the compressor 20 described above. Therefore, the diffuser 26 is a component of the compressor 20 and is also a component of the intermediate shaft cover 50. As shown in FIGS. 3 to 5, the diffuser 26 includes an outer diffuser 27 that defines an outer peripheral edge of the annular diffuser space S and an inner diffuser 28 that defines an inner peripheral edge of the diffuser space S. FIG. 3 is a cross-sectional view of a main part of the intermediate shaft cover 50. FIG. 4 is a developed view showing a state in which the intermediate shaft cover 50 is developed in the circumferential direction Dc and viewed from the radial outer side Dro. FIG. 5 is a cross-sectional view taken along line V-V in FIG. 4.

The inner diffuser 28 has a tubular shape centered on the axis Ar.

The outer diffuser 27 is an outer cover with respect to the inner cover 61. The outer diffuser 27 has a tubular outer diffuser main body 27m centered on the axis Ar, and a cooling air jacket 27j that is provided on an outer periphery of the outer diffuser main body 27m, which is a portion of the outer diffuser main body 27m on the axial downstream side Dad. The outer diffuser main body 27m defines the outer peripheral edge of the annular diffuser space S. The outer diffuser main body 27m is formed such that an inner diameter gradually increases toward the axial downstream side Dad. An end of the outer diffuser 27 on the axial upstream side Dau is attached to the gas turbine casing 14. The cooling air jacket 27j has an annular shape centered on the axis Ar. The cooling air jacket 27j forms an annular outer space P1 together with the outer diffuser main body 27m on an outer peripheral side of the outer diffuser main body 27m, which is a portion of the outer diffuser main body 27m on the axial downstream side Dad. The cooling air line 4 of the cooling air supply device 1 is connected to the cooling air jacket 27j. The cooling air Acl from the cooling air line 4 can flow into the outer space P1 in the cooling air jacket 27j.

The flange 52 forms an annular shape centered on the axis Ar and is connected to the annular cooling air jacket 27j centered on the axis Ar. The flange 52 is disposed on an outer peripheral side of the diffuser space S at an end of the outer diffuser 27 on the axial downstream side Dad.

The inner cover 61 is disposed in a region on the radial inner side Dri with respect to the diffuser 26, which is on the axial downstream side Dad with respect to the diffuser 26 and on the axial upstream side Dau with respect to the plurality of turbine rotor blade rows 43. The inner cover 61 is formed in a tubular shape centered on the axis Ar and covers the intermediate rotor shaft 12m. The inner cover 61 includes a tubular inner first cover 62 centered on the axis Ar and a tubular inner second cover 63 centered on the axis Ar. An end on the axial upstream side Dau of the inner first cover 62 is connected to an end on the axial downstream side Dad of the inner diffuser 28. The inner second cover 63 is disposed on the radial inner side Dri of the inner first cover 62 and is connected to the inner first cover 62. The inner second cover 63 forms an annular inner passage P4 that extends in the axial direction Da, on the radial outer side Dro of the intermediate rotor shaft 12m, which is the radial inner side Dri of the inner first cover 62, together with the inner first cover 62.

The plurality of struts 53 are arranged in the circumferential direction Dc. Each of the struts 53, all of which extend from an outer periphery of the inner first cover 62 toward the radial outer side Dro and are connected to the flange 52. Therefore, the plurality of struts 53 are indirectly connected to the outer diffuser 27 as the outer cover through the flange 52.

Each strut 53 has a thick wall portion 55, a thin wall portion 57, and a gradual wall thickness change portion 56. In the strut 53 of FIG. 3, a portion with a lattice pattern is the thick wall portion 55, a portion with a stripe pattern is the gradual wall thickness change portion 56, and a portion without a pattern is the thin wall portion 57. The thick wall portion 55 is formed in a region including an outer connecting portion 540 that is indirectly connected to the outer diffuser 27 as the outer cover, which includes an end on the radial outer side Dro, in the strut 53. The thin wall portion 57 is formed in a region including an inner connecting portion 54i that includes an end on the radial inner side Dri and that is connected to the inner cover 61, in the strut 53. A thickness of the thin wall portion 57 in the circumferential direction Dc is smaller than a thickness of the thick wall portion 55 in the circumferential direction Dc. The gradual wall thickness change portion 56 is formed between the thick wall portion 55 and the thin wall portion 57 in the strut 53. A thickness of the gradual wall thickness change portion 56 in the circumferential direction Dc gradually decreases from the thick wall portion 55 toward the thin wall portion 57. The thickness of the gradual wall thickness change portion 56 is the same as the thickness of the thick wall portion 55 at a boundary between the gradual wall thickness change portion 56 and the thick wall portion 55, and is the same as the thickness of the thin wall portion 57 at a boundary between the gradual wall thickness change portion 56 and the thin wall portion 57.

In the strut 53, a portion on the radial inner side Dri with respect to an extension line L (see FIG. 3) of a generatrix intersecting with a virtual plane that includes the axis Ar on an inner peripheral surface of the outer diffuser 27 is the thin wall portion 57. In other words, in the strut 53, a portion on the radial outer side Dro with respect to the extension line L is the gradual wall thickness change portion 56 and the thick wall portion 55.

A cooling air passage P through which the cooling air Acl from the cooling air line 4 of the cooling air supply device 1 can be fed to the turbine rotor shaft 42 is formed in the intermediate shaft cover 50. The outer space P1 of the outer diffuser 27 described above is a part of the cooling air passage P.

A strut space 58 is formed in each strut 53. The strut space 58 communicates with the outer space P1 through a connecting passage P2 that is a part of the cooling air passage P. The strut space 58 extends from a connection surface with the flange 52 in the strut 53 to an inner peripheral surface of the inner first cover 62. The connecting passage P2 is formed in the cooling air jacket 27j and the flange 52 of the outer diffuser 27.

The passage cover 59 that defines a strut passage P3, which is a part of the cooling air passage P, is disposed in the strut space 58. The passage cover 59 is not disposed in the connecting passage P2. One end of the strut passage P3 communicates with the connecting passage P2. In addition, the other end of the strut passage P3 communicates with the inner passage P4 of the inner cover 61. That is, the outer space P1, the connecting passage P2, the strut passage P3, and the inner passage P4 described above communicate with each other to form the cooling air passage P configured to feed the cooling air Acl from the outside of the gas turbine casing 14 to the turbine rotor shaft 42.

As shown in FIG. 2, a cooling air passage 42p communicating with the cooling air passage P of the intermediate shaft cover 50 is formed in the turbine rotor shaft 42. Among the plurality of turbine rotor blade rows 43 attached to the turbine rotor shaft 42, a cooling air passage 43p communicating with the cooling air passage 42p of the turbine rotor shaft 42 is formed in a plurality of rotor blades 43b constituting the turbine rotor blade row 43 on the most axial upstream side Dau. The cooling air Acl from the cooling air passage P of the intermediate shaft cover 50 is fed to the cooling air passage 43p of the rotor blade 43b through the cooling air passage 42p of the turbine rotor shaft 42. The cooling air Acl cools the rotor blade 43b in a process of passing through the cooling air passage 43p of the rotor blade 43b. The cooling air Acl flows out from an outer surface of the rotor blade 43b into the combustion gas passage 49.

As described, in the present embodiment, in the strut 53, the thick wall portion 55 having a larger thickness in the circumferential direction Dc than the thickness of the thin wall portion 57 is formed in the region including the outer connecting portion 540 indirectly connected to the outer diffuser 27 that is the outer cover. Therefore, strength of the outer connecting portion 540 in the strut 53 can be increased. Moreover, in the present embodiment, in the strut 53, in the region including the inner connecting portion 54i connected to the inner cover 61, the thin wall portion 57 having a smaller thickness in the circumferential direction Dc than the thickness of the thick wall portion 55 is formed. Therefore, it is possible to suppress narrowing of a width of a flow path of the compressed air Acom that is jetted from the diffuser 26 and that passes through a side of the strut 53. Therefore, in the present embodiment, it is possible to suppress resistance in a process in which the compressed air Acom passes through the side of the strut 53.

Most of the compressed air Acom that is jetted from the diffuser 26 and that passes through the side of the strut 53 flows through the radial inner side Dri with respect to the extension line L of the generatrix on the inner peripheral surface of the outer diffuser 27. In the present embodiment, in the strut 53, the thin wall portion 57 is on the radial inner side Dri with respect to the extension line L, and the gradual wall thickness change portion 56 and the thick wall portion 55 are on the radial outer side Dro with respect to the extension line L. Therefore, in the present embodiment, in the strut 53, the resistance in the process in which the compressed air Acom passes through the side of the strut 53 can be suppressed more than in a case where a part of the gradual wall thickness change portion 56 or a part of the thick wall portion 55 is present on the radial inner side Dri with respect to the extension line L.

In the present embodiment, since the gradual wall thickness change portion 56 is present between the thick wall portion 55 and the thin wall portion 57, it is possible to suppress stress concentration between the thick wall portion 55 and the thin wall portion 57.

In the present embodiment, the cooling air Acl from the outside of the gas turbine casing 14 can be fed to the turbine rotor shaft 42 by the cooling air passage P composed of the outer space P1, the connecting passage P2, the strut passage P3, and the inner passage P4. In addition, in the present embodiment, the passage cover 59 in the strut space 58 is not disposed in the connecting passage P2 that is a part of the cooling air passage P. Therefore, in the present embodiment, the cooling air Acl flowing in the connecting passage P2 can be used to directly cool a periphery of the connecting passage P2. Therefore, in the present aspect, the outer connecting portion 540 of the strut 53 can be efficiently cooled, and a decrease in strength due to an increase in temperature of the outer connecting portion 540 of the strut 53 can be suppressed.

### Second Embodiment of Intermediate Shaft Cover

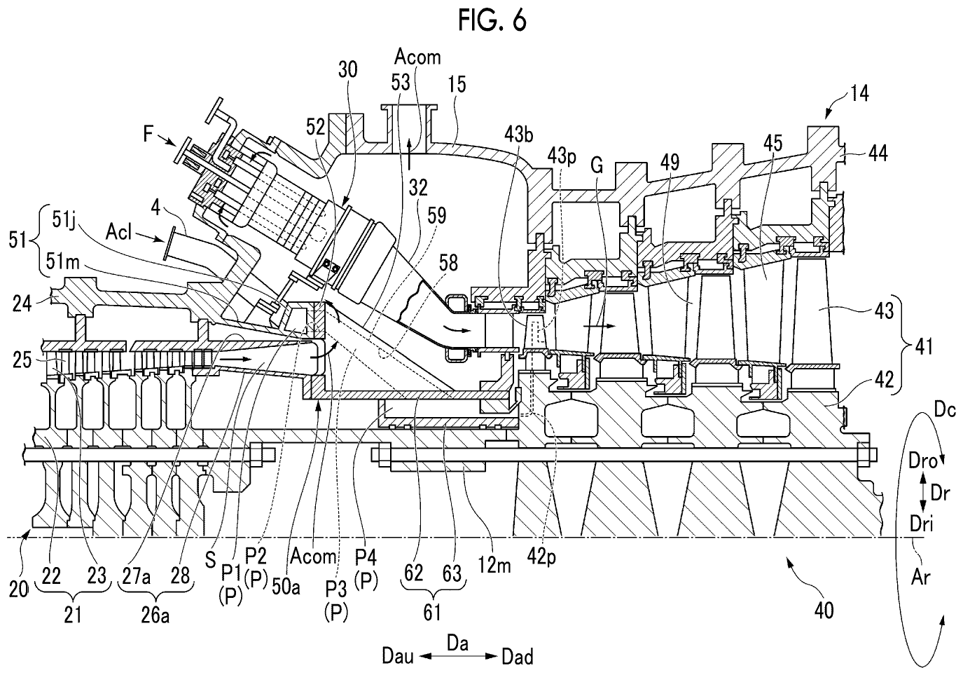

A second embodiment of the intermediate shaft cover will be described with reference to FIG. 6.

An intermediate shaft cover 50a in the present embodiment is a modification example of the intermediate shaft cover 50 in the first embodiment. The intermediate shaft cover 50a in the present embodiment includes a diffuser 26a, the inner cover 61, the plurality of struts 53, the passage cover 59 provided for each of the plurality of struts 53, and the flange 52, similarly to the intermediate shaft cover 50 in the first embodiment. The intermediate shaft cover 50a in the present embodiment further includes an outer cover 51.

The outer cover 51 has a tubular outer cover main body 51m centered on the axis Ar and a cooling air jacket 51j that is provided on an outer periphery of the outer cover main body 51m, which is a portion of the outer cover main body 51m on the axial downstream side Dad. The annular outer cover main body 51m covers an outer peripheral side of the diffuser 26a. An end of the outer cover 51 on the axial upstream side Dau is attached to the gas turbine casing 14. The cooling air jacket 51j has an annular shape centered on the axis Ar. The cooling air jacket 51j forms the annular outer space P1 together with the outer cover main body 51m on an outer peripheral side of the outer cover main body 51m, which is a portion of the outer cover main body 51m on the axial downstream side Dad. The cooling air line 4 of the cooling air supply device 1 is connected to the cooling air jacket 51j. In the outer space P1 in the cooling air jacket 51j, the cooling air Acl can flow in from the cooling air line 4.

The diffuser 26a in the present embodiment has an outer diffuser 27a and the inner diffuser 28, similarly to the diffuser 26 in the first embodiment. The inner diffuser 28 in the present embodiment is the same as the inner diffuser 28 in the first embodiment. On the other hand, the outer diffuser 27a in the present embodiment is different from the outer diffuser 27 in the first embodiment. As described above, the outer cover 51 has the cooling air jacket 51j that forms the outer space P1. Therefore, the outer diffuser 27a in the present embodiment does not have the cooling air jacket 27j of the outer diffuser 27 in the first embodiment. An end of the outer diffuser 27a on the axial downstream side Dad in the present embodiment is in contact with or is close to an end of the outer cover 51 on the axial downstream side Dad in the radial direction Dr.

The flange 52 in the present embodiment is formed in an annular shape centered on the axis Ar and is connected to the annular cooling air jacket 51j centered on the axis Ar, similarly to the flange 52 in the first embodiment. However, the flange 52 in the present embodiment is connected to the cooling air jacket 51j of the outer cover 51.

The inner cover 61 in the present embodiment has the same configuration as that of the inner cover 61 in the first embodiment and covers an outer periphery of the intermediate rotor shaft 12m. Therefore, the inner cover 61 in the present embodiment also has the tubular inner first cover 62 centered on the axis Ar and the tubular inner second cover 63 centered on the axis Ar, similarly to the inner cover 61 in the first embodiment. An end on the axial upstream side Dau of the inner first cover 62 is connected to an end on the axial downstream side Dad of the inner diffuser 28. The inner second cover 63 is disposed on the radial inner side Dri of the inner first cover 62 and is connected to the inner first cover 62. The inner second cover 63 forms an annular inner passage P4 that extends in the axial direction Da, on the radial outer side Dro of the intermediate rotor shaft 12m, which is the radial inner side Dri of the inner first cover 62, together with the inner first cover 62.

The plurality of struts 53 in the present embodiment have the same configuration as that of the plurality of struts 53 in the first embodiment and are arranged in the circumferential direction Dc. Therefore, each of the struts 53 in the present embodiment, all of which extend from the outer periphery of the inner first cover 62 to the radial outer side Dro and are connected to the flange 52. Therefore, the plurality of struts 53 are indirectly connected to the outer cover 51 through the flange 52.

Each strut 53 in the present embodiment, although not shown in FIG. 6, also has a thick wall portion, a thin wall portion, and a gradual wall thickness change portion, similarly to each strut 53 in the first embodiment. In the strut 53 in the present embodiment, a portion on the radial inner side Dri with respect to the extension line L of a generatrix intersecting a virtual plane including the axis Ar on an inner peripheral surface of the outer diffuser 27a is the thin wall portion 57, as in the strut 53 in the first embodiment.

As in the first embodiment, the strut space 58 is formed in each strut 53. The strut space 58 communicates with the outer space P1 of the outer cover 51 through the connecting passage P2 which is a part of the cooling air passage P. The connecting passage P2 is formed in the cooling air jacket 51j of the outer cover 51 and the flange 52.

As in the first embodiment, the passage cover 59 that defines the strut passage P3, which is a part of the cooling air passage P, is disposed in the strut space 58. The passage cover 59 is not disposed in the connecting passage P2. The outer space P1, the connecting passage P2, the strut passage P3, and the inner passage P4 communicate with each other to form the cooling air passage P configured to feed the cooling air Acl from the outside of the gas turbine casing 14 to the turbine rotor shaft 42.

As described above, in the present embodiment as well, similarly to the first embodiment, in the strut 53, the thick wall portion having a larger thickness in the circumferential direction De than the thickness of the thin wall portion is formed in the region including the outer connecting portion indirectly connected to the outer cover 51. Therefore, the strength of the outer connecting portion in the strut 53 can be increased. Further, in the present embodiment as well, in the strut 53, a thin wall portion having a thickness in the circumferential direction De smaller than the thickness of the thick wall portion is formed in the region including the inner connecting portion connected to the inner cover 61. Therefore, the resistance in the process in which the compressed air Acom is jetted from the diffuser 26a and passes through the side of the strut 53 can be suppressed.

As described above, the outer cover 51 may be a different component from that of the outer diffuser 27a, unlike in the first embodiment.

### Third Embodiment of Intermediate Shaft Cover

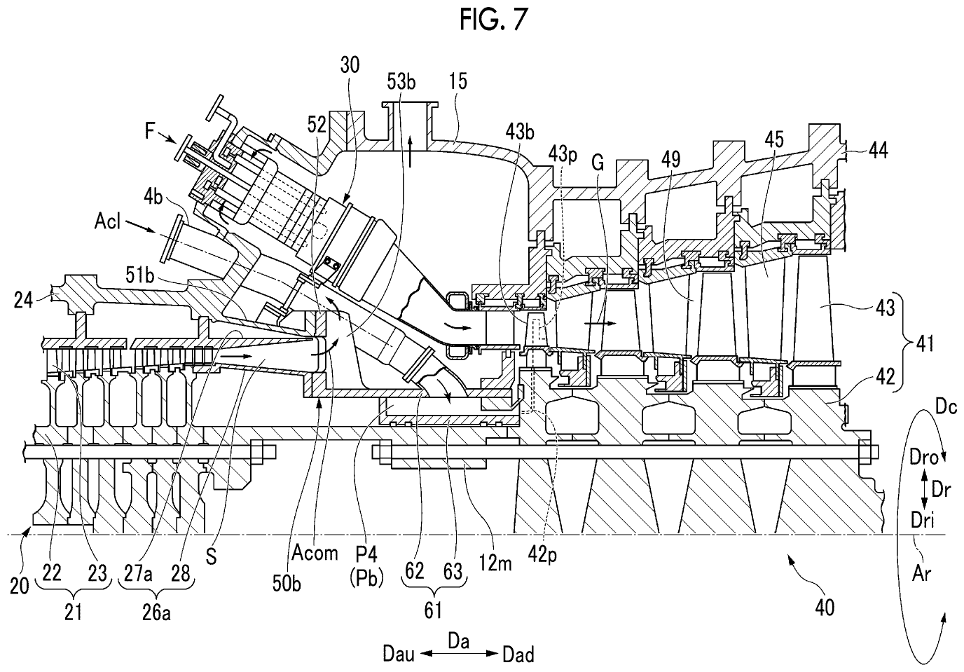

A third embodiment of the intermediate shaft cover will be described with reference to FIG. 7.

An intermediate shaft cover 50b in the present embodiment is a modification example of the intermediate shaft cover 50a in the second embodiment. The intermediate shaft cover 50b in the present embodiment includes the diffuser 26a, an outer cover 51b, the inner cover 61, a plurality of struts 53b, and the flange 52, similarly to the intermediate shaft cover 50a in the second embodiment.

The outer cover 51b in the present embodiment has a tubular shape centered on the axis Ar, similarly to the outer cover 51 in the second embodiment. However, the outer cover 51b in the present embodiment does not have the cooling air jacket 51j of the outer cover 51 in the second embodiment.

The diffuser 26a in the present embodiment has the same outer diffuser 27a and inner diffuser 28 as the diffuser 26a in the second embodiment. The end of the outer diffuser 27a on the axial downstream side Dad in the present embodiment is in contact with or is close to an end of the outer cover 51b on the axial downstream side Dad in the radial direction Dr.

The flange 52 in the present embodiment is formed in an annular shape centered on the axis Ar, similarly to the flange 52 in the second embodiment. The flange 52 is connected to the end of the outer cover 51b on the axial downstream side Dad.

The inner cover 61 in the present embodiment has the same configuration as that of the inner cover 61 in the first embodiment and covers an outer periphery of the intermediate rotor shaft 12m. Therefore, the inner cover 61 in the present embodiment also has the tubular inner first cover 62 centered on the axis Ar and the tubular inner second cover 63 centered on the axis Ar, similarly to the inner cover 61 in the second embodiment. An end on the axial upstream side Dau of the inner first cover 62 is connected to an end on the axial downstream side Dad of the inner diffuser 28. The inner second cover 63 is disposed on the radial inner side Dri of the inner first cover 62 and is connected to the inner first cover 62. The inner second cover 63 forms an annular inner passage P4 that extends in the axial direction Da, on the radial outer side Dro of the intermediate rotor shaft 12m, which is the radial inner side Dri of the inner first cover 62, together with the inner first cover 62.

The plurality of struts 53b in the present embodiment are arranged in the circumferential direction De, similarly to the plurality of struts 53 in the second embodiment. Therefore, each of the struts 53b in the present embodiment, all of which extend from the outer periphery of the inner first cover 62 to the radial outer side Dro and are connected to the flange 52. Therefore, the plurality of struts 53b are indirectly connected to the outer cover 51b through the flange 52.

Each strut 53b in the present embodiment, although not shown in FIG. 7, also has a thick wall portion, a thin wall portion, and a gradual wall thickness change portion, similarly to each strut 53 in the first embodiment. In the strut 53b in the present embodiment, a portion on the radial inner side Dri with respect to the extension line L of a generatrix intersecting a virtual plane including the axis Ar on an inner peripheral surface of the outer diffuser 27a is the thin wall portion, as in the strut 53 in the first embodiment.

Unlike the strut 53 in each of the above embodiments, the strut space 58 is not formed in the strut 53b in the present embodiment. Therefore, the intermediate shaft cover 50b in the present embodiment does not have the passage cover 59 in the first embodiment and the second embodiment.

A cooling air line 4b of the cooling air supply device 1 is connected to the inner first cover 62. Therefore, in the present embodiment, the cooling air Acl from the cooling air supply device 1 can flow into the inner passage P4 of the inner cover 61 without passing through the outer cover 51b and the struts 53 and 53b. That is, a cooling air passage Pb of the intermediate shaft cover 50b in the present embodiment is composed of only the inner passage P4 of the inner cover 61.

As described above, in the present embodiment as well, similarly to the first embodiment and the second embodiment, in the strut 53b, the thick wall portion having a larger thickness in the circumferential direction De than the thickness of the thin wall portion is formed in the region including the outer connecting portion indirectly connected to the outer cover 51b. Therefore, the strength of the outer connecting portion in the strut 53b can be increased. Further, in the present embodiment as well, in the strut 53b, a thin wall portion having a thickness in the circumferential direction De smaller than the thickness of the thick wall portion is formed in the region including the inner connecting portion connected to the inner cover 61. Therefore, the resistance in the process in which the compressed air Acom is jetted from the diffuser 26a and passes through the side of the strut 53b can be suppressed.

As described above, the cooling air Acl may be directly supplied from the cooling air supply device 1 to the inner passage P4 of the inner cover 61 without forming the outer space Pl in the outer cover 51b and without forming the strut space 58 in the plurality of struts 53b. It should be noted that the present embodiment is a modification example of the second embodiment. However, in the first embodiment as well, the cooling air Acl may be directly supplied from the cooling air supply device 1 to the inner passage P4 of the inner cover 61 without forming the outer space P1 in the outer diffuser 27, which is the outer cover, and without forming the strut space 58 in the plurality of struts 53.

### Fourth Embodiment of Intermediate Shaft Cover

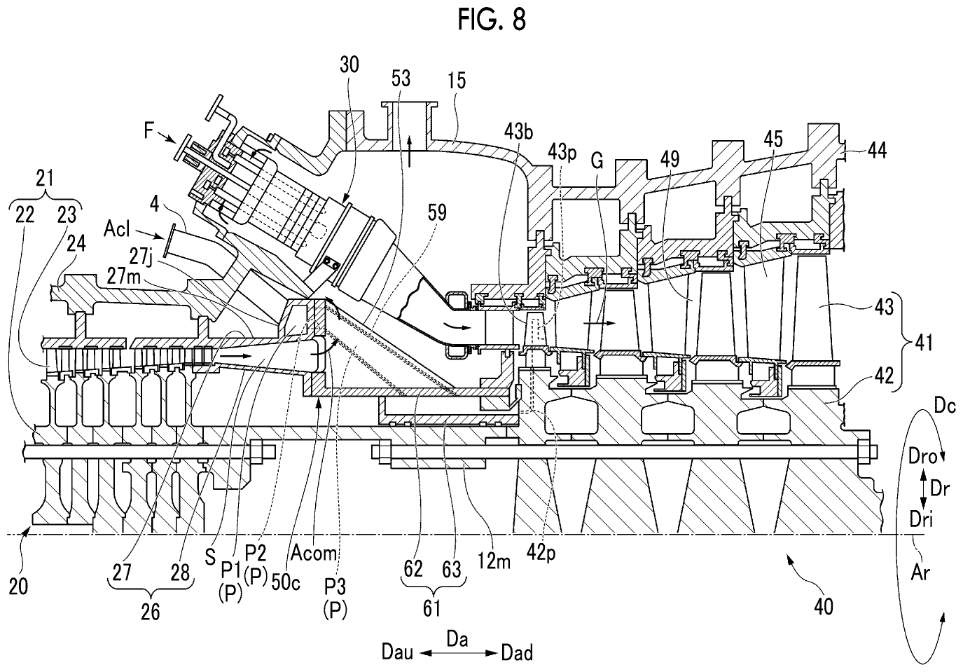

A fourth embodiment of the intermediate shaft cover will be described with reference to FIG. 8.

An intermediate shaft cover 50c in the present embodiment is a modification example of the intermediate shaft cover 50 in the first embodiment. The intermediate shaft cover 50c in the present embodiment is the same as the intermediate shaft cover 50 in the first embodiment except that the flange 52 of the intermediate shaft cover 50 in the first embodiment is not provided.

The plurality of struts 53 in the present embodiment are directly connected to the cooling air jacket 27j of the outer diffuser 27, which is the outer cover. Therefore, the intermediate shaft cover 50c in the present embodiment does not have the flange 52.

The present embodiment is a modification example of the first embodiment. However, in the second embodiment and the third embodiment as well, the flange 52 may not be provided, and the plurality of struts 53 and 53b may be directly connected to the outer covers 51 and 51b. That is, the plurality of struts 53 and 53b may be directly connected to an annular member such as a part of the outer diffuser 27, a part of the outer covers 51 and 51b, and the flange 52. In this case, the annular member needs to be disposed on the outer peripheral side of the diffuser space S at the end of the outer diffuser on the axial downstream side Dad. In addition, the annular member needs to be provided to be unable to move relative to the gas turbine casing 14.

In addition, the present disclosure is not limited to each of the embodiments described above. Various additions, modifications, substitutions, partial deletions, and the like can be made without departing from the conceptual idea and gist of the present invention derived from the contents defined in the claims and equivalents thereof.

### Supplementary Notes

The intermediate shaft covers 50, 50a, 50b, and 50c in each of the above-described embodiments are understood as follows, for example.

(1) An intermediate shaft cover according to a first aspect is applied to a gas turbine 10 described below.

The gas turbine 10 includes a gas turbine rotor 11 that is rotatable about an axis Ar, and a gas turbine casing 14 that covers an outer periphery of the gas turbine rotor 11. The gas turbine rotor 11 includes a gas turbine rotor shaft 12 that extends in an axial direction Da, a plurality of compressor rotor blade rows 23 that are provided in a portion of the gas turbine rotor shaft 12 on an axial upstream side Dau among the axial upstream side Dau and an axial downstream side Dad in the axial direction Da. and a plurality of turbine rotor blade rows 43 that are provided in a portion of the gas turbine rotor shaft 12 on the axial downstream side Dad with an interval from the plurality of compressor rotor blade rows 23 to the axial downstream side Dad.

Intermediate shaft covers 50, 50a, 50b, and 50c include diffusers 26 and 26a through which compressed air Acom that has passed through the plurality of compressor rotor blade rows 23 can flow and which form an annular diffuser space S centered on the axis Ar, a tubular inner cover 61 that covers an intermediate rotor shaft 12m between the plurality of compressor rotor blade rows 23 and the plurality of turbine rotor blade rows 43 in the gas turbine rotor shaft 12, on the axial downstream side Dad with respect to the diffusers 26 and 26a, annular outer covers 27, 51, and 51b that cover an outer peripheral side of the diffuser space S and that are connected to the gas turbine casing 14, and struts 53 and 53b that extend from an outer periphery of the inner cover 61 to a radial outer side Dro with respect to the axis Ar and that are directly or indirectly connected to the outer covers 27, 51, and 51b. The struts 53 and 53b include a thick wall portion 55 having a large thickness in a circumferential direction De with respect to the axis Ar and a thin wall portion 57 having a smaller thickness in the circumferential direction De than the thickness of the thick wall portion 55. The thick wall portion 55 is formed in a region including an outer connecting portion 540 that includes an end on the radial outer side Dro and that is directly or indirectly connected to the outer covers 27, 51, and 51b, in the struts 53 and 53b. The thin wall portion 57 is formed in a region including an inner connecting portion 54i that includes an end on a radial inner side Dri with respect to the axis Ar and that is connected to the inner cover 61, in the struts 53 and 53b.

In the present aspect, in the struts 53 and 53b, the thick wall portion 55 having a larger thickness in the circumferential direction De than the thickness of the thin wall portion 57 is formed in the region including the outer connecting portion 540 that is directly or indirectly connected to the outer covers 27, 51, and 51b. Therefore, strength of the outer connecting portion 540 in the struts 53 and 53b can be increased. Moreover, in the present aspect, in the struts 53 and 53b, in the region including the inner connecting portion 54i connected to the inner cover 61, the thin wall portion 57 having a smaller thickness in the circumferential direction De than the thickness of the thick wall portion 55 is formed. Therefore, it is possible to suppress narrowing of a width of a flow path of the compressed air Acom that is jetted from the diffusers 26 and 26a and that passes through a side of the struts 53 and 53b. Therefore, in the present aspect, it is possible to suppress resistance in a process in which the compressed air Acom passes through the side of the struts 53 and 53b.

(2) In an intermediate shaft cover according to a second aspect, in the intermediate shaft covers 50, 50a, 50b, and 50c according to the first aspect, the struts 53 and 53b include a gradual wall thickness change portion 56 in which the thickness in the circumferential direction De gradually decreases from the thick wall portion 55 toward the thin wall portion 57, between the thick wall portion 55 and the thin wall portion 57.

In the present aspect, since the gradual wall thickness change portion 56 is present between the thick wall portion 55 and the thin wall portion 57, it is possible to suppress stress concentration between the thick wall portion 55 and the thin wall portion 57.

(3) In an intermediate shaft cover according to a third aspect, in the intermediate shaft covers 50, 50a, 50b, and 50c according to the first aspect or the second aspect, the diffusers 26 and 26a include outer diffusers 27 and 27a that define an outer peripheral edge of the diffuser space S and an inner diffuser 28 that defines an inner peripheral edge of the diffuser space S.

The outer diffusers 27 and 27a are formed such that an inner diameter gradually increases toward the axial downstream side Dad. In the struts 53 and 53b, a portion on the radial inner side Dri with respect to an extension line L of a generatrix intersecting with a virtual plane that includes the axis Ar on an inner peripheral surface of the outer diffusers 27 and 27a is the thin wall portion 57.

In the present aspect, most of the compressed air Acom that is jetted from the diffusers 26 and 26a and that passes through the side of the struts 53 and 53b flows through the radial inner side Dri with respect to the extension line L of the generatrix on the inner peripheral surface of the outer diffusers 27 and 27a. Therefore, in the present aspect, it is possible to suppress resistance in a process in which the compressed air Acom passes through the side of the struts 53 and 53b.

(4) In an intermediate shaft cover according to a fourth aspect, in the intermediate shaft cover 50 according to any one of the first aspect to the third aspect, the diffuser 26 includes an outer diffuser 27 that defines an outer peripheral edge of the diffuser space S and an inner diffuser 28 that defines an inner peripheral edge of the diffuser space S.

The outer cover 27 is the outer diffuser.

The outer covers 27, 51, and 51b may be different components from the outer diffusers 27 and 27a, but may be the outer diffuser 27 as in the present aspect.

(5) In an intermediate shaft cover according to a fifth aspect,
in the intermediate shaft covers 50, 50a, and 50c according to any one of the first aspect to the fourth aspect, a passage cover 59 that defines a strut passage P3 which is a part of a cooling air passage P configured to feed cooling air Acl from an outside of the gas turbine casing 14 to a turbine rotor shaft 42 in which the plurality of turbine rotor blade rows 43 are provided in the gas turbine rotor shaft 12 is further provided.

The outer covers 27 and 51 include an outer space Pl into which the cooling air Acl from the outside of the gas turbine casing 14 can flow, as a part of the cooling air passage P.

The strut 53 includes a strut space 58 that communicates with the outer space P1. The passage cover 59 is disposed in the strut space 58. The outer space P1 in the outer covers 27 and 51 and the strut passage P3 in the passage cover 59 are connected through a connecting passage P2 which is a part of the cooling air passage P. The passage cover 59 is not disposed in the connecting passage P2. The inner cover 61 includes an inner passage P4 capable of communicating with the strut passage P3 and configured to feed the cooling air Acl from the strut passage P3 to the turbine rotor shaft 42, as a part of the cooling air passage P.

In the present aspect, the cooling air Acl from the outside of the gas turbine casing 14 can be fed to the turbine rotor shaft 42 by the cooling air passage P composed of the outer space P1, the connecting passage P2, the strut passage P3, and the inner passage P4. In addition, in the present aspect, the passage cover 59 in the strut space 58 is not disposed in the connecting passage P2 that is a part of the cooling air passage P. Therefore, in the present aspect, the cooling air Acl flowing in the connecting passage P2 can be used to directly cool a periphery of the connecting passage P2. Therefore, in the present aspect, the outer connecting portion 540 of the strut 53 can be efficiently cooled, and a decrease in strength due to an increase in temperature of the outer connecting portion 540 of the strut 53 can be suppressed.

(6) In an intermediate shaft cover according to a sixth aspect, in the intermediate shaft covers 50, 50a, and 50b according to any one of the first aspect to the fifth aspect, a flange 52 that forms an annular shape centered on the axis Ar and that is connected to the outer covers 27, 51, and 51b is further provided.

The struts 53 and 53b are connected to the flange 52.

The end of the struts 53 and 53b on the radial outer side Dro may be directly connected to the outer covers 27, 51, and 51b, but may be indirectly connected to the outer covers 27, 51, and 51b through the flange 52, as in the present aspect.

For example, the gas turbine 10 in each of the above-described embodiments is understood as follows.

(7) In a gas turbine according to a seventh aspect,
the intermediate shaft covers 50, 50a, 50b, and 50c according to any one of the first aspect to the sixth aspect, the gas turbine rotor 11, the gas turbine casing 14, and a combustor 30 that is attached to the gas turbine casing 14 and that generates combustion gas G by combusting fuel F in compressed air Acom that has passed into the diffuser space S are provided.

The combustor 30 is formed such that the combustion gas G is guided to the plurality of turbine rotor blade rows 43.

### INDUSTRIAL APPLICABILITY

According to one aspect of the present disclosure, it is possible to suppress resistance of a flow of air from a compressor while increasing strength of a strut of a gas turbine. It is possible to reduce running costs in liquefaction and vaporization of a gas.

### REFERENCE SIGNS LIST

1: cooling air supply device

2: bleeding air line

3: cooler

4, 4b: cooling air line

5: boost compressor

9: generator

10: gas turbine

11: gas turbine rotor

12: gas turbine rotor shaft

12m: intermediate rotor shaft

14: gas turbine casing

15: intermediate casing

16: exhaust casing

20: compressor

21: compressor rotor

22: compressor rotor shaft

23: compressor rotor blade rows

24: compressor casing

25: compressor stator vane rows

26, 26a: diffuser

27, 27a: outer diffuser

27m: outer diffuser main body

27j: cooling air jacket

28: inner diffuser

30: combustor

31: burner

32: combustion cylinder (or transition piece)

40: turbine

41: turbine rotor

42: turbine rotor shaft

42p: cooling air passage

43: turbine rotor blade row

43b: rotor blade

43p: cooling air passage

44: turbine casing

45: turbine stator blade row

49: combustion gas passage

50, 50a, 50b, 50c: intermediate shaft cover

51, 51b: outer cover

51m: outer cover main body

51j: cooling air jacket

52: flange

53, 53b: strut

54o: outer connecting portion

54i: inner connecting portion

55: thick wall portion

56: gradual wall thickness change portion

57: thin wall portion

58: strut space

59: passage cover

61: inner cover

62: inner first cover

63: inner second cover

P, Pb: cooling air passage

P1: outer space

P2: connecting passage

P3: strut passage

P4: inner passage

S: diffuser space

A: air

Acom: compressed air

Acl: cooling air

F: fuel

G: combustion gas

EG: exhaust gas

Ar: axis

Da: axial direction

Dau: axial upstream side

Dad: axial downstream side

Dc: circumferential direction

Dr: radial direction

Dri: radial inner side

Dro: radial outer side

L: extension line

1. An intermediate shaft cover of a gas turbine including
a gas turbine rotor that is rotatable about an axis, and
a gas turbine casing that covers an outer periphery of the gas turbine rotor,
in which the gas turbine rotor includes
a gas turbine rotor shaft that extends in an axial direction,
a plurality of compressor rotor blade rows that are provided in a portion of the gas turbine rotor shaft on an axial upstream side among the axial upstream side and an axial downstream side in the axial direction, and
a plurality of turbine rotor blade rows that are provided in a portion of the gas turbine rotor shaft on the axial downstream side with an interval from the plurality of compressor rotor blade rows to the axial downstream side, the intermediate shaft cover comprising:
a diffuser through which compressed air that has passed through the plurality of compressor rotor blade rows can flow and which forms an annular diffuser space centered on the axis;
a tubular inner cover that covers an intermediate rotor shaft between the plurality of compressor rotor blade rows and the plurality of turbine rotor blade rows in the gas turbine rotor shaft, on the axial downstream side with respect to the diffuser;
an annular outer cover that covers an outer peripheral side of the diffuser space and that is connected to the gas turbine casing; and
a strut that extends from an outer periphery of the inner cover to a radial outer side with respect to the axis and that is directly or indirectly connected to the outer cover,
wherein the strut includes a thick wall portion having a large thickness in a circumferential direction with respect to the axis and a thin wall portion having a smaller thickness in the circumferential direction than the thickness of the thick wall portion,
the thick wall portion is formed in a region including an outer connecting portion that includes an end on the radial outer side and that is directly or indirectly connected to the outer cover, in the strut, and
the thin wall portion is formed in a region including an inner connecting portion that includes an end on a radial inner side with respect to the axis and that is connected to the inner cover, in the strut.

2. The intermediate shaft cover according to claim 1,
wherein the strut includes a gradual wall thickness change portion in which the thickness in the circumferential direction gradually decreases from the thick wall portion toward the thin wall portion, between the thick wall portion and the thin wall portion.

3. The intermediate shaft cover according to claim 1,
wherein the diffuser includes an outer diffuser that defines an outer peripheral edge of the diffuser space and an inner diffuser that defines an inner peripheral edge of the diffuser space,
the outer diffuser is formed such that an inner diameter gradually increases toward the axial downstream side, and
in the strut, a portion on the radial inner side with respect to an extension line of a generatrix intersecting with a virtual plane that includes the axis on an inner peripheral surface of the outer diffuser is the thin wall portion.

4. The intermediate shaft cover according to claim 1,
wherein the diffuser includes an outer diffuser that defines an outer peripheral edge of the diffuser space and an inner diffuser that defines an inner peripheral edge of the diffuser space, and
the outer cover is the outer diffuser.

5. The intermediate shaft cover according to claim 1, further comprising:
a passage cover that defines a strut passage which is a part of a cooling air passage configured to feed cooling air from an outside of the gas turbine casing to a turbine rotor shaft in which the plurality of turbine rotor blade rows are provided in the gas turbine rotor shaft,
wherein the outer cover includes an outer space into which the cooling air from the outside of the gas turbine casing can flow, as a part of the cooling air passage,
the strut includes a strut space that communicates with the outer space,
the passage cover is disposed in the strut space,
the outer space in the outer cover and the strut passage in the passage cover are connected through a connecting passage which is a part of the cooling air passage,
the passage cover is not disposed in the connecting passage, and
the inner cover includes an inner passage capable of communicating with the strut passage and configured to feed the cooling air from the strut passage to the turbine rotor shaft, as a part of the cooling air passage.

6. The intermediate shaft cover according to claim 1, further comprising:
a flange that forms an annular shape centered on the axis and that is connected to the outer cover,
wherein the strut is connected to the flange.

7. A gas turbine comprising:
the intermediate shaft cover according to claim 1;
the gas turbine rotor;
the gas turbine casing; and
a combustor that is attached to the gas turbine casing and that generates combustion gas by combusting fuel in compressed air that has passed into the diffuser space,
wherein the combustor is formed such that the combustion gas is guided to the plurality of turbine rotor blade rows.
